(19) United States
(12) Patent Application Publication
(10) Pub. No.: US 2005/0082263 A1
(43) Pub. Date: Apr. 21, 2005

(54) Nozzle for plasma torch

(75) Inventors: Tetsuo Koike, Tokyo (JP); Akira Furujo, Tokyo (JP); Yoshiyuki Kato, Tokyo (JP)

Correspondence Address: Townsend & Banta;Suite 900, South Building, 601 Pennsylvania Avenue, N.W., Washington, DC, 20004, US

(73) Assignee: Koike Sanso Kogyo Co., Ltd.

(21) Appl. No.: 10/959,574

(22) Filed: Oct. 7, 2004

(30) Foreign Application Priority Data
Oct. 16, 2003 (JP) 2003-356421(PAT.)

(51) Int. Cl. B23K 10/00

(52) U.S. Cl. 219/121.49; 219/121.5

(57) ABSTRACT

The present invention relates to a nozzle for a plasma torch, in which the nozzle is detachably attached to the plasma torch and has an injection port for injecting a plasma arc formed at the center thereof, the nozzle for a plasma torch comprising: a water supplying pipe for cooling water; a water draining pipe for the cooling water; an annular water passage arranged around the injection port; and a plurality of connecting water passages for independently connecting the water supplying pipe to the annular water passage and the water draining pipe to the annular water passage.

### BACKGROUND OF THE INVENTION

1. Field of the Invention

The present invention relates to a nozzle for a plasma torch and, more particularly, to a cutting nozzle for injecting a plasma arc toward a workpiece to be cut for the purpose of cutting, in which so-called high quality cutting can be achieved at a narrow cutting width with enhanced cutting performance.

2. Description of the Related Art

In the case where a workpiece to be cut such as a steel plate or a stainless steel plate is cut, there has been frequently adopted a plasma cutting method capable of cutting at an increased cutting speed in comparison with a gas cutting method. In the plasma cutting method, a plasma arc is injected toward a workpiece to be cut, thereby fusing a base material by heat of the plasma arc and cutting the workpiece to be cut while removing the fused material by the injection energy of the plasma arc.

The configuration of a plasma torch disclosed in Japanese Patent Application Publication (JP-B) No. 3-27309 will be simply explained below as an embodiment of a typical plasma cutting method. An electrode is fixed to the center of a plasma torch. A nozzle (also referred to as a chip), which has an injection port for injecting a plasma arc at the center thereof and is detachably attached to the plasma torch, is disposed opposite to the electrode. The nozzle is fixed by tightening a cap to the plasma torch. Furthermore, a passage is formed for allowing cooling water to flow between the peripheral surface of the nozzle and the circumferential surface of the cap. Moreover, cooling water passages (i.e., a supplying passage and a draining passage) for cooling the electrode and the nozzle are formed on the side of the plasma torch, wherein the supplying passage and the draining passage are opened to the passage formed between the nozzle and the cap.

With the above-described configuration, the cooling water supplied to the plasma torch cools the electrode in contact with the reverse of the electrode, and then, is supplied to the passage formed between the cap and the nozzle. During passing through the passage, the cooling water cools the nozzle, and thereafter, is drained to the outside of the plasma torch. In this manner, the electrode and the nozzle are cooled by the cooling water, thus preventing any excessive heating due to the heat of the plasma arc.

In the plasma torch configured as described above, the plasma arc formed in association with the energization between the electrode and the workpiece to be cut is narrowed by cooling when it passes through an injection port of the nozzle, to be thus injected toward the workpiece to be cut, thereby fusing the workpiece to be cut, and further, cutting it while removing the fused material.

The plasma cutting has raised a problem of a cutting width greater than that by the gas cutting, although the cutting speed is high in the plasma cutting. As a consequence, the cutting width is reduced by finely narrowing the plasma arc in the plasma cutting. In particular, a current density need be increased in the case of high quality cutting. For such necessity, the plasma arc need be sufficiently narrowed.

In order to narrow the plasma arc, it is necessary to effectively cool the nozzle, in particular, the surroundings of the injection port for injecting the plasma arc. However, as disclosed in JP-B No. 3-27309, in the case where the passage for the cooling water is formed between the peripheral surface of the nozzle and the circumferential surface of the cap, the cooling water supplied from the plasma torch circulates in the vicinity of a main unit (at a shortest distance from the supplying passage to the draining passage), although the passage is formed near the injection port. Therefore, there has arisen a problem that the flow of the cooling water is stagnated at the tip of the nozzle (i.e., in the vicinity of the injection port), resulting in insufficient cooling.

### SUMMARY OF THE INVENTION

An object of the present invention is to provide a nozzle for a plasma torch capable of effectively cooling with cooling water.

In order to achieve the above-described object, a nozzle for a plasma torch according to the present invention, in which the nozzle is detachably attached to the plasma torch and has an injection port for injecting a plasma arc formed at the center thereof, comprises: a water supplying pipe for cooling water; a water draining pipe for the cooling water; an annular water passage arranged around the injection port; and a plurality of connecting water passages for independently connecting the water supplying pipe to the annular water passage and the water draining pipe to the annular water passage. In this case, the plurality of connecting water passages may be arranged over the entire circumference of the nozzle, the water supplying pipe and the water draining pipe have enlarged ends, and the water supplying pipe and the water draining pipe may be connected to the plurality of connecting water passages, respectively. Furthermore, it is preferable that the nozzle for a plasma torch has three or more connecting water passages arranged in such a manner as to divide the entire circumference of the nozzle at equal angles, at least one of the connecting water passages is connected to only either one of the water supplying passage and the water draining passage.

Moreover, in the nozzle for a plasma torch the connecting water passage and the annular water passage may be formed at a joint surface between a first nozzle member and a second nozzle member in combination, which constitute the nozzle for a plasma torch.

In the nozzle for the plasma torch, the cooling water supplied through the cooling water supplying passage is introduced to the annular water passage through the connecting water passage, so as to sufficiently cool the surroundings of the injection port for the plasma arc in the nozzle, and thereafter, is drained through the cooling water draining pipe through the other connecting water passage. That is to say, the cooling water can form a flow from the supplying passage to the draining passage by the use of the connecting water passages and the annular water passage, thus sufficiently cooling the nozzle.

Furthermore, the plurality of connecting water passages are arranged over the entire circumference of the nozzle, and the circumferential surface of the nozzle can be cooled with the cooling water flowing in the connecting water passages by connecting the water supplying pipe and the water draining pipe to the plurality of connecting water passages, respectively. Moreover, there are provided three or more connecting water passages, all of the connecting water passages are stretched across the cooling water supplying pipe and the cooling water draining pipe by connecting at least one connecting water passage to only either one of the water supplying passage and the water draining passage, thus preventing any circulation of the cooling water inside of the connecting water passages, so as to secure the circulation of the cooling water through the annular water passage.

Additionally, since the connecting water passage and the annular water passage are formed at the joint surface between the first nozzle member and the second nozzle member in combination, which constitute the nozzle for the plasma torch, the connecting water passage and the annular water passage can be readily formed.

### BRIEF DESCRIPTION OF THE DRAWINGS

FIG. 1 is a cross-sectional view showing the configuration of a nozzle which can inject a secondary air flow in association with a plasma arc;

FIG. 2 is a cross-sectional view showing the shape of an outer nozzle;

FIG. 3 is a cross-sectional view showing the shape of an inner nozzle;

FIG. 4 is a cross-sectional view showing the configuration of a plasma torch;

FIG. 5 is a cross-sectional view showing essential parts of the plasma torch in enlargement;

FIGS. 6A to 6C are views showing the shape of an inner nozzle in a second embodiment; and

FIGS. 7A to 7D are charts explanting relationship between the number of connecting water passages, and the water supplying pipe and the water draining pipe.

### DETAILED DESCRIPTION OF THE PREFERRED EMBODIMENTS

A description will be given below of a best mode of a nozzle for a plasma torch according to the present invention. A nozzle according to the present invention is constituted of a combination of a first nozzle member and a second nozzle member, thus achieving effective cooling with respect to the nozzle by forming a cooling water passage for allowing cooling water to pass between the nozzle members, so as to circulate the cooling water through the cooling water passage. The effective nozzle cooling can finely narrow a plasma arc, and further, high quality cutting can be achieved at a high current density.

The cooling water can be brought into direct contact with the back surface of a circumferential wall of an injection port, which is formed at the center of the nozzle so as to inject the plasma arc, by allowing the cooling water to flow inside of the nozzle, thereby effectively cooling a portion in the nozzle exposed to a highest temperature. Consequently, it is possible to exhibit a thermal pinch effect with respect to the plasma arc passing through the injection port in a favorable state, thus preventing the nozzle from being damaged due to the plasma arc even by reducing the diameter of the injection port.

Although a structure for allowing the cooling water to flow inside of the nozzle is not especially limited, it is preferable that, for example, a central portion of the first nozzle member disposed on a side of a main unit of the plasma torch or a central portion of the second nozzle member disposed apart from the side of the main unit of the plasma torch should be formed into a wall shape with a predetermined thickness; that the injection port penetrating in a thickness direction should be formed on the wall while a fitting portion for allowing the wall having the injection port formed thereon to be fitted at the center of the other nozzle member; and that a sufficient clearance should be formed for allowing the cooling water to flow between the facing surfaces when both of the nozzle members are fitted to each other.

The clearance formed between the nozzle members can be configured as the cooling water passage without any water leakage by sealing the clearance formed at the fitting portion after the walls formed at the centers of the first and second nozzle members are fitted to the fitting portion. The cooling water passage is formed as an annular passage surrounding the wall having the injection port formed thereon. Consequently, the supplied cooling water cools the wall in contact with the wall during passing through the annular passage, and then, is drained.

A dimensional condition such as a thickness or a length of the wall having the injection port formed thereon is not particularly limited. It is merely necessary to provide a dimension which can preferably form the injection port set in the target nozzle. In particular, in the case where the plasma torch is directed to not cutting but fusing a workpiece, the injection port formed in the nozzle is susceptible to a damage by an adverse influence of fused slug or the like. In this case, it is preferable that the injection port should be formed of a pipe, which can be replaced with another pipe. In the such a nozzle, it is desirable to set the dimension of the wall in consideration of the thickness of the pipe.

Although the cross-sectional area of the cooling water passage is not particularly limited, the cooling water passage should preferably have a cross-sectional area corresponding to that of a cooling water supplying port formed on the side of the plasma torch. With the above-described cross-sectional area, it is possible to effectively cool the nozzle by allowing the cooling water supplied to the plasma torch to flow without exerting any large resistance on the cooling water.

Although a material constituting the nozzle is not particularly limited, the nozzle member having the injection port for injecting the plasma arc formed at the center thereof should be desirably made of an economic material having high heat resistance and high thermal conductivity. Such a material is exemplified by copper or a copper alloy, which can be selectively used.

Cutoff means in cutting off the water by fitting the wall having the injection port formed at either one of the first and second nozzle members to the fitting portion formed at the other nozzle member is not particularly limited. The cutoff means merely can prevent the cooling water flowing in the cooling water passage formed between the first and second nozzle members from being leaked from the fitting portion between a rod-like portion and a fitting hole. Such cutoff means includes brazing, bonding, press-fitting and the like, which should be preferably selected for use.

Moreover, at least one connecting water passage is connected to either one of the supplying pipe and the draining pipe by forming at least three independent connecting water passages communicating with the annular water passage formed between the first and second nozzle members, so that the cooling water can be securely introduced to the annular water passage without any circulation of the cooling water inside of the connecting water passage. As a consequence, the supplied cooling water can securely reach the wall having the injection port formed thereon, thereby effectively cooling the nozzle.

The number of independent water passages is at least three, and it may be any as long as it is three or more. However, since the number of water passages is naturally limited, it is preferable that the number should be appropriately set in consideration of machining means in forming the water passage and the conditions such as the dimension of the nozzle.

Any of the independent water passages need communicate substantially directly with the cooling water supplying passage formed on the side of the plasma torch while another of the independent water passages need communicate substantially directly with the draining passage. In this manner, in order to allow the independent water passages to communicate directly with the supplying passage and the draining passage on the side of the plasma torch, it is preferable to bring a surface on a side of an opening end of the water passage (i.e., a rear end of the nozzle) into direct contact with a surface, at which the supplying pipe and the draining pipe on the side of the plasma torch are formed. Incidentally, it is desirable to provide a structure in which the supplying pipe and the draining pipe should be connected to the plurality of connecting water passages, respectively.

In particular, in order to configure such that any of the water passages can securely face to the supplying pipe and the draining pipe in contact when the nozzle is attached to the plasma torch, the area of the opening end of a hole should be preferably increased without forming a simple hole communicating with the supplying pipe and the draining pipe in one-to-one correspondence to the connecting water passages. In order to increase the area of the opening end in the above-described manner, the hole may be formed into, for example, an arcuate groove. However, positioning means may be configured between the nozzle and the plasma torch.

In the case where the surface at the opening end of the independent water passage is brought into direct contact with the surface having the supplying passage and the draining passage on the side of the plasma torch formed thereat, the surfaces need not always be formed as surfaces perpendicular to the axis of the plasma torch, but may be inclined surfaces transverse to the axis.

The independent water passage simply sufficiently communicates with the annular water passage formed between the first and second nozzle members, and the length of the water passage cannot be limited. However, in order to allow the cooling water to securely reach the wall having the injection port formed thereon, it is preferable to form the independent water passage up to a position in the proximity of the wall on the annular water passage. In this manner, the flow of the supplied cooling water is restricted by elongating the independent water passage up to the position in the proximity of the wall, thereby effectively cooling the circumferential surface of the nozzle.

A structure for forming the independent connecting water passage is not particularly limited, but the independent connecting water passage may have any structure which communicates with the cooling water supplying pipe or the cooling water draining pipe and individually restrict a flowing direction. In order to form the above-described independent water passage, for example, at least three projecting pieces (i.e., dividing pieces) are formed at the peripheral surface of the first nozzle member, and then, they can be used as partitions constituting three or more connecting water passages by bringing the projecting portion of the dividing piece into contact with the circumferential surface of the second member. The above-described dividing piece can be formed by cutting the first nozzle member of a polygonal rod-like material, or may be formed by hot forging or cold forging inclusive of component rolling. Otherwise, the dividing piece may be formed at the circumferential surface of a base of the second nozzle member by cutting or forging.

Additionally, a dividing member may be constituted by connecting the plurality of dividing pieces to each other via ring-like pieces, and then, it may be disposed at the periphery of the first nozzle member or the circumference of the second nozzle member. In this manner, the shape or structure of the dividing piece is not limited, but it may be appropriately selected according to the condition inclusive of the dimension of the nozzle.

Embodiment 1

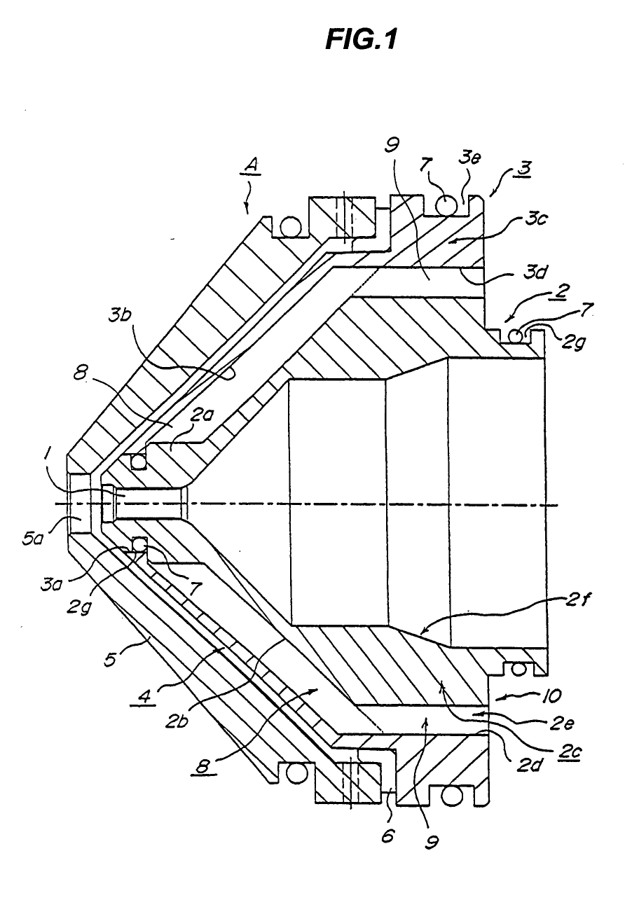

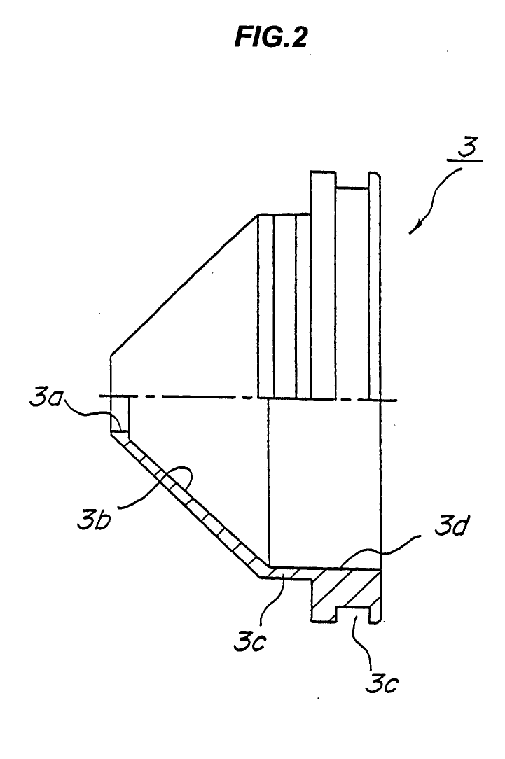

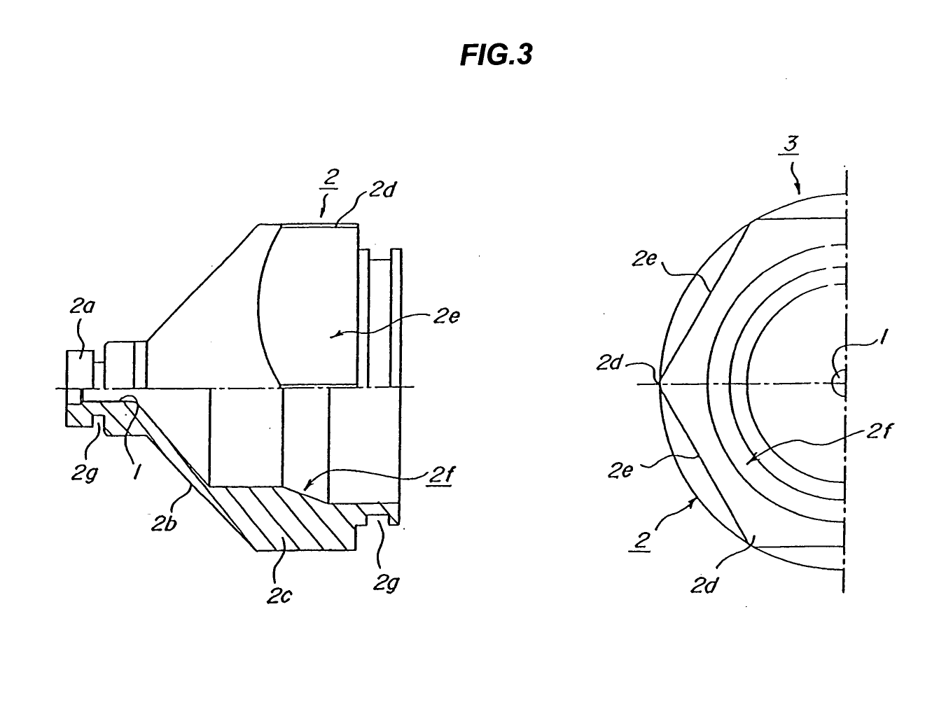

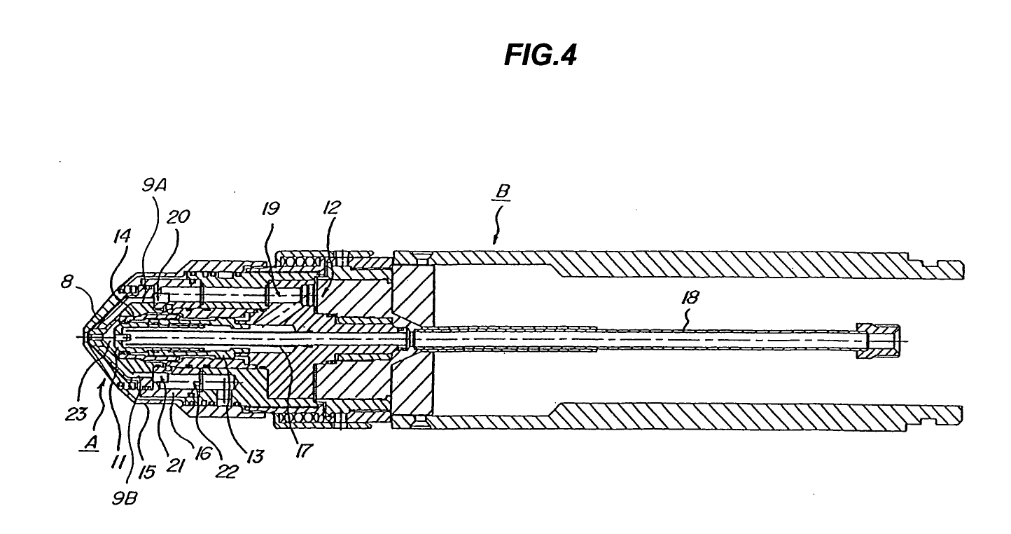

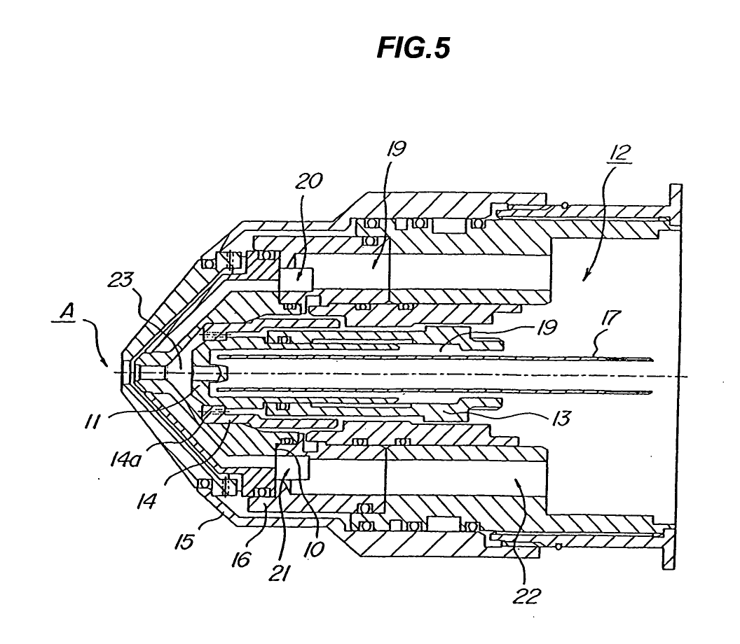

Next, a description will be given below of a nozzle in a preferred embodiment according to the present invention in reference to the attached drawings. FIG. 1 is a cross-sectional view showing the configuration of a nozzle which can inject a secondary air flow in association with a plasma arc; FIG. 2 is a cross-sectional view showing the shape of an outer nozzle; FIG. 3 is a cross-sectional view showing the shape of an inner nozzle; FIG. 4 is a cross-sectional view showing the configuration of a plasma torch; and FIG. 5 is a cross-sectional view showing essential parts of the plasma torch in enlargement.

Prior to the description of a nozzle A in the present embodiment, explanation will be simply made below on the configuration of a plasma torch B in reference to FIGS. 4 and 5. The plasma torch B shown in FIGS. 4 and 5 is constituted of mainly a passage for cooling water to be supplied to an electrode 11 and the nozzle A.

The plasma torch B is configured such that the electrode 11 is detachably attached to an electrode table 13 disposed at the center of a main body 12. There is provided a cylindrical insulator 14 having a hole 14a for allowing gaseous plasma to pass through the periphery of the electrode 11 and an insulating property. The nozzle A is further disposed around the insulator 14. The rear end of the nozzle A is brought into surface contact with a cooling water supplying/draining member 16 disposed in the main body 12 by tightening a cap 15 engaged to the nozzle A to the main body 12, and further, the nozzle A and the insulator 14 are secured to the main body 12.

Although in the present embodiment, the fore surface of the water supplying/draining member 16 is formed as a surface perpendicular to the axis of the main body 12, it may be a slantwise tapered surface.

A cooling pipe 17 is disposed coaxially with the main body 12, and further, a supplying pipe 18 for the cooling water is connected to the cooling pipe 17. A water passage 19 connected to the circumferential and peripheral sides of the cooling pipe 17 is formed in the state in which the electrode 11 faces to an opening end of the cooling pipe 17 by fixing the electrode 11 to the electrode table 13. The water passage 19 is constituted of a hole, and is connected to a water supplying passage 20 formed at the water supplying/draining member 16 through the inside of the main body 12, wherein the water supplying passage 20 is connected to the nozzle A. A draining passage 21 is formed at a position of the water supplying/draining member 16 symmetrically with the water supplying passage 20 in reference to the center axis. Another water passage 22 constituted of a hole is connected to the draining passage 21, and further, is connected to a draining pipe, not shown to the water passage 21.

In the present embodiment, the water supplying passage 20 and the water draining passage 21 are constituted of grooves formed into an arcuate shape in reference to the holes constituting the water passages 19 and 22, respectively, wherein an interval between ends of the grooves is set to a dimension greater than the width of the connecting water passage 9 independently formed at the nozzle A, described later. Consequently, in attaching the nozzle A to the plasma torch B, the water supplying passage 20 and the water draining passage 21 cannot simultaneously communicate with one and the same connecting water passage 9 irrespective of the state of the fixing position.

In the plasma torch B configured as described above, when the cooling water is supplied to the supplying pipe 18, the supplied cooling water cools the water in contact with the reverse surface of the electrode 11 through the water passage 19 formed inside of the cooling pipe 17. Thereafter, the water reaches the water supplying pipe 20 formed at the water supplying/draining member 16 through the water passage 19 formed between the peripheral surface of the cooling pipe 17 and the electrode table 13, to be thus supplied to the nozzle A. The cooling water supplied to the nozzle A cools the nozzle A, and then, is drained through the water draining pipe 21 formed at the water supplying/draining member 16. Thereafter, the cooling water is drained to the outside of the plasma torch B through the water passage 22 and a water draining pipe, not shown.

In the state in which the plasma torch B and the nozzle A incorporated in the plasma torch B are cooled as described above, gaseous plasma is supplied to a plasma chamber 23 formed around the electrode 11 via the insulator 14, and then, a pilot arc is formed by electrically discharging between the electrode 11 and the nozzle A. Subsequently, the pilot arc is injected toward a workpiece to be cut, not shown, from an injection hole formed at the nozzle A. The pilot arc reaches the workpiece to be cut, thereby forming a plasma arc (i.e., a main arc) by achieving energization between the electrode 11 and the workpiece to be cut. The workpiece to be cut is fused with the plasma arc and the fused material is removed, so that a groove is formed at the workpiece to be cut by penetration of the removed base material in a thickness direction.

As a consequence, in the state in which the energization is maintained between the electrode 11 and the workpiece to be cut, that is, in which the plasma arc is formed, a groove continuous to the workpiece to be cut is formed by relatively moving the plasma torch B and the workpiece to be cut in a desired direction, thereby cutting the workpiece to be cut in a desired shape.

Next, a description will be given below of the nozzle A in the present embodiment in reference to FIGS. 1 to 3. The nozzle A in the present embodiment is configured in such a manner as to inject the secondary air flow in association to the plasma arc. However, the existence of the secondary air flow is not limited in the nozzle for the plasma torch according to the present invention. That is to say, the nozzle for the plasma torch according to the present invention is configured such that the injection port, through which the plasma arc is injected, can be effectively cooled by forming the cooling water passage inside of the nozzle, irrespective of the existence of the secondary air flow or the existence of a high-order air flow such as a tertiary or more air flow around the plasma arc injected from the injection port.

The nozzle A comprises: an inner nozzle 2 having a wall 2a, on which an injection port 1 for injecting the plasma arc is formed at the center, and serving as a first nozzle member; an outer nozzle 3 having a fitting hole 3a at a fitting portion, at the center of which the wall 2a of the inner nozzle 2 is fitted, and serving as a second nozzle member; a secondary air flow cap 5 disposed on a peripheral side of the outer nozzle 3, and having a secondary air flow passage 4 formed at the peripheral surface of the outer nozzle 3 and an injection port 5a for injecting the plasma arc and the secondary air flow; and an insulator 6 interposed between the outer nozzle 3 and the secondary air flow cap 5.

Here, in the present embodiment, the injection port 1 is formed at the inner nozzle 2. However, it is to be understood that the injection port 1 may be formed at the outer nozzle 3; in this case, the fitting portion is formed at the inner nozzle 2.

The inner nozzle 2 includes the wall 2a having the injection port 1 at the center thereof, a divergently tapered portion 2b (i.e., a tapered surface 2b) formed continuously from the wall 2a, and a base 2c formed continuously to a portion of the tapered portion 2b having a greatest diameter and in parallel to an axis. The wall 2a has a length and a thickness enough to form a length and a diameter set by the injection port 1, and is formed into a shape projecting from an end (i.e., a tip) on a side of a small diameter of the tapered portion 2b.

The taper angle, length or the like of the tapered portion 2b is not particularly limited, but is set according to a size of a space defined between the main body 12 and the cap 15 in the plasma torch B.

The base 2c is continuous to the tapered portion 2b, and is formed in parallel to the axis of the nozzle A. In particular, the inner nozzle 2 is made of a hexagonal rod material. The tapered portion 2b and the wall 2a are formed by cutting the hexagonal rod. The angled portion of the hexagonal rod functions as a dividing piece 2d for forming independent water passages with the angles remaining at the base 2c, and further, a flat surface 2e functions as a surface constituting the independent water passage.

Incidentally, the circumferential side of the inner nozzle 2 is formed as a surface 2f constituting the plasma chamber 23 between the fore surface of the electrode 11 and the inner nozzle 2 when the nozzle A is attached to the main body 12 of the plasma torch B. Moreover, grooves 2g for allowing an O-ring 7 to be disposed therein are formed at the peripheral surface of the wall 2a and the peripheral surface of the base 2c.

The outer nozzle 3 includes the fitting hole 3a for allowing the wall 2a formed at the inner nozzle 2 at the center to be fitted, a divergently tapered portion 2b (i.e., a tapered surface 3b) continuous to the fitting hole 3a, and a base 3c parallel to the axis of the nozzle A in continuation to a portion of the tapered portion 2b having a greatest diameter and having a cylindrical inner surface 3d.

The fitting hole 3a can exhibit a sealing property in contact with the O-ring 7 disposed on the wall 2a by allowing the wall 2a formed at the inner nozzle 2 to be fitted. However, after the fitting hole 3a and the wall 2a are fitted to each other, a higher sealing property (i.e., water tightness) is secured by, for example, injecting an adhesive or brazing.

When the outer nozzle 3 and the inner nozzle 2 are fitted to each other, an annular water passage 8 serving as an annular cooling water passage for circulating the cooling water is formed between the tapered surface 2b and the tapered surface 3b. Moreover, the inner surface 3d of the base 3c defines an independent connecting water passage 9 with the flat surface 2e of the base 2c and the inner surface 3d in contact with the dividing piece 2d formed at the base 2c of the inner nozzle 2. Consequently, the connecting water passage 9 communicates with the annular water passage 8 formed between the tapered surfaces 2b and 3b of the nozzles 2 and 3, respectively, and further, is constituted as six independent connecting water passages 9.

When the outer nozzle 3 and the inner nozzle 2 are integrated with each other into a combined member, end surfaces 10 at the rear ends of the bases 2c and 3c of the nozzles 2 and 3 become substantially flush with each other. Although in the present embodiment, the end surface 10 is configured to be a surface perpendicular to the axis of the nozzle A, the angle is not limited to a right angle but it may be a tapered surface. When the nozzle A is attached in the main body 12 of the plasma torch B, the end surfaces 10 are brought into surface contact with the fore surface of the water supplying/draining member 16, to be connected to the water supplying pipe 20 and the water draining pipe 21 formed in the water supplying/draining member 16.

In other words, any one of at least three independent connecting water passages 9 formed in the nozzle A is connected to the water supplying pipe 20 while any one of the other connecting water passages 9 is connected to the water draining pipe 21 by attaching the nozzle A in the nozzle table 13 disposed in the main body 12 of the plasma torch B. As a consequence, the annular water passage 8 formed at the nozzle A is connected to the water supplying passage 20 via any one 9A of the connecting water passages 9, and at the same time, is connected to the water draining pipe 21 via any one 9B of the connecting water passages 9, thereby constituting a series of cooling water passages.

Here, a groove 3e for disposing the O-ring 7 therein is formed around the base 3c in the outer nozzle 3.

In the nozzle A configured as described above, when the cooling water is supplied to any one or two out of the six water passages 9 formed between the bases 2c and 3c in the inner nozzle 2 and the outer nozzle 3, respectively, the supplied cooling water is introduced from the connecting water passage 9A to the annular water passage 8, at which cools the wall 2a in contact, and thereafter, the cooling water is drained through the connecting water passage 9B located on the side opposite to the connecting water passage 9A on the supplying side.

Consequently, all of the supplied cooling water securely passes through the annular water passage 8, and during the passing process, the cooling water cools the wall 2a, thereby substantially cooling the injection port 1. As a result, it is possible to enhance the cooling effect with respect to the plasma arc passing through the injection port 1, so as to finely narrow the plasma arc.

The inventors of the present application carried out a comparison experiment at a plasma current of 260 A by using the conventional plasma torch and nozzle disclosed in JP-B No. 3-27309 and the nozzle according to the present invention. The conventional nozzle had a diameter of the injection port of 2.3 mm, wherein a current density was about 63 A/mm². When the plasma arc was injected toward the workpiece to be cut from the nozzle under that condition, a difference between the temperature of the cooling water supplied to the main body of the plasma torch and the temperature on the water draining side ranged from about 5° C. to 6° C. In contrast, the diameter of the injection port in the nozzle according to the present invention was set to 1.9 mm, so that the current density could be increased up to 92 A/mm² at that time. When the plasma arc was injected from the nozzle under that condition, a difference in temperature of the cooling water between the supplying side and the draining side ranged from about 7° C. to 8° C.

As described above, it is clear that the effective cooling can be achieved since the difference in temperature of the cooling water becomes greater in the nozzle according to the present invention. Furthermore, the plasma arc passing through the injection port of the nozzle can be finely narrowed by achieving the effective cooling, thus resulting in an increase in current density of the plasma arc so as to achieve the cutting of a high quality.

Embodiment 2

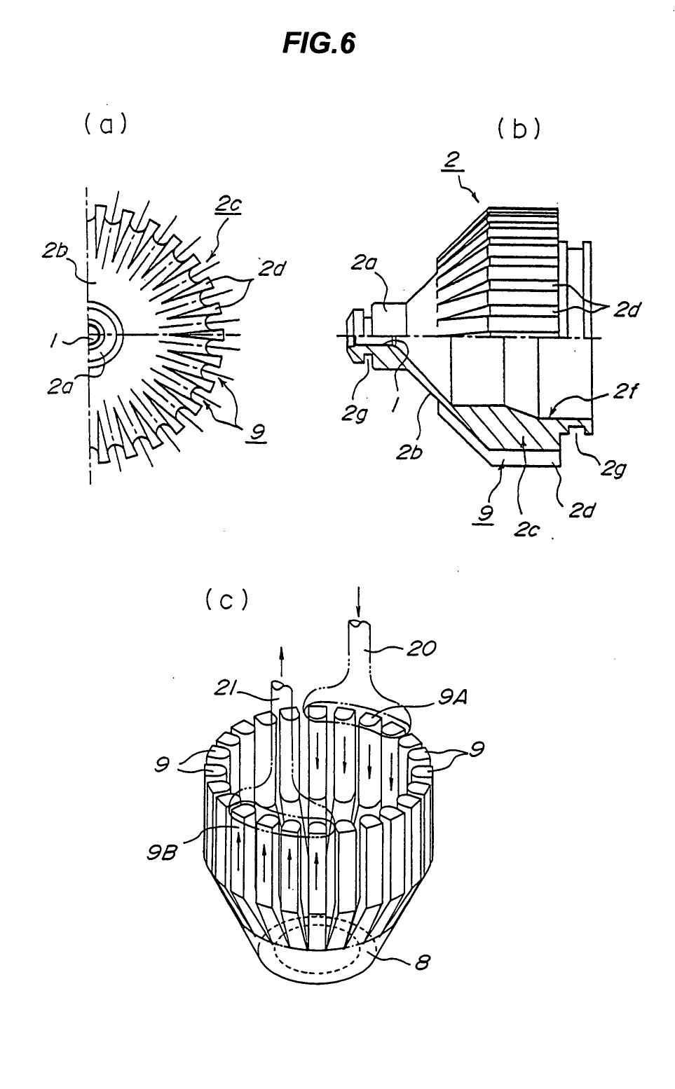

Next, an inner nozzle in a second embodiment will be explained in reference to FIG. 6. Incidentally, the same component parts and the component parts having the same functions as those in the first embodiment are designated by the same reference numerals, and therefore, the explanation will be omitted.

As shown in FIGS. 6A and 6B, an inner nozzle 2 includes numerous dividing pieces 2d formed from a tapered portion 2b (i.e., a tapered surface 2b) to a base 2c. Independent water passages 9 in the same number as that of dividing pieces 2d are formed by fitting the inner nozzle 2 to an outer nozzle 3. In the inner nozzle 2 in the present embodiment, the dividing pieces 2d extend toward the tapered surface 2b, so that the independent connecting water passage 9 becomes long, thereby more securely cooling a wall 2a.

Furthermore, FIG. 6C is a perspective view showing an annular water passage 8, the connecting water passages 9, a water supplying passage 20 and a water draining passage 21. Here, each of the water supplying passage 20 and the water draining passage 21 is enlarged at the lower end thereof in a sectorial shape, to thus communicate with the plurality of connecting water passages 9.

Incidentally, the inner nozzle 2 in the present embodiment can be formed by molding inclusive of forging, or by the combination of forging and cutting.

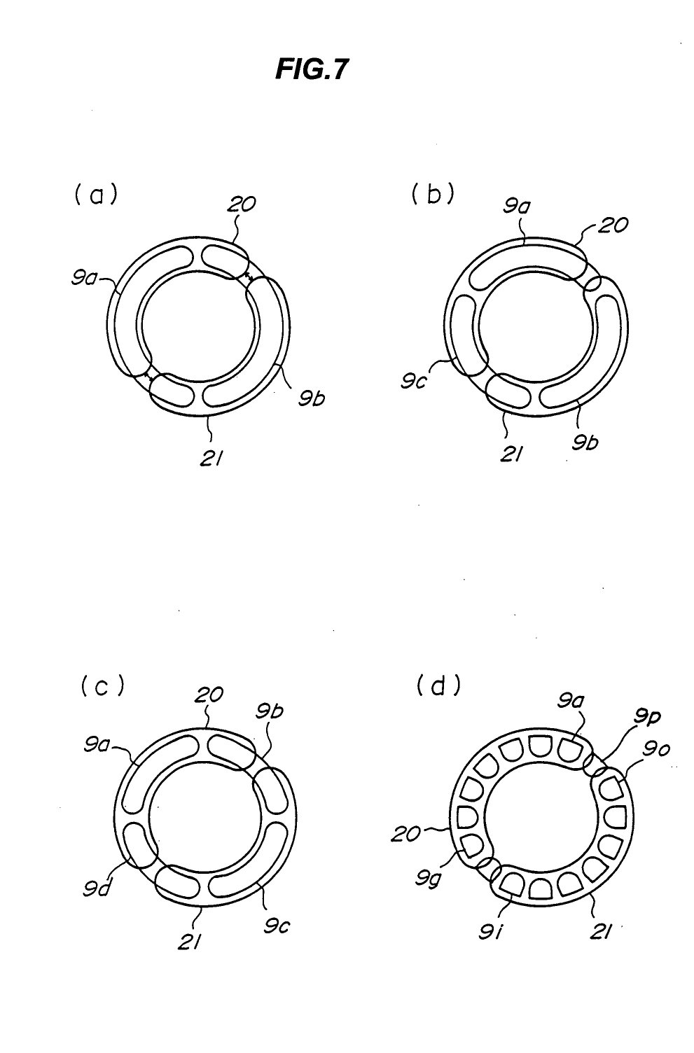

Moreover, explanation will be made below on the relationship between the number of connecting water passages 9, and the water supplying pipe 20 and the water draining pipe 21 in reference to FIGS. 7A to 7D. Each of FIGS. 7A to 7D shows an example in which the width of each of the water supplying pipe 20 and the water draining pipe 21 is maximum in a semi-arcuate shape, wherein FIG. 7A shows an example in which the number of connecting water passages 9 is two (i.e., connecting water passages 9a and 9b); FIG. 7B shows an example in which the number of connecting water passages 9 is three (i.e., connecting water passages 9a to 9c); FIG. 7C shows an example in which the number of connecting water passages 9 is four; and FIG. 7D shows an example in which the number of connecting water passages 9 is 16 (i.e., connecting water passages 9a to 9p).

In the case where the number of connecting water passages 9 is only two as shown in FIG. 7A, the two connecting water passages 9a and 9b overlap both of the water supplying pipe 20 and the water draining pipe 21 as long as the connecting water passages 9a and 9b cannot completely mate with the water supplying pipe 20 and the water draining pipe 21, respectively. In this case, there is an undesirable possibility that a sufficient quantity of cooling water cannot reach the annular water passage, not shown, since a part of cooling water supplied from the water supplying passage 20 is short-circuited to the water draining pipe 21 inside of the connecting water passage 9.

Otherwise, in the case where the number of connecting water passages 9 is three as shown in FIG. 7B, at least one connecting water passage 9 is connected to only one of the water supplying pipe 20 and the water draining pipe 21 (in FIG. 7B, the connecting water passage 9b is connected to only the water draining pipe 21), so that the cooling water flows through the annular water passage if the quantity of water to be supplied is equal to that of water to be drained.

Moreover, in the case where the number of connecting water passages 9 is four as shown in FIG. 7C, at least one connecting water passage 9 is connected to the water supplying pipe 20 and at least one connecting water passage 9 is connected to the water draining passage 21 (in FIG. 7C, the connecting water passage 9a is connected to only the water supplying pipe 20, and the connecting water passage 9c is connected to only the water draining pipe 21), so that the cooling water securely flows through the annular water passage.

Alternatively, in the case where the connecting water passage 9 is further subdivided as shown in FIG. 7D, no connecting water passage 9 overlaps both of the water supplying pipe 20 and the water draining pipe 21, thereby eliminating any cooling water which is short-circuited to flow through the connecting water passage 9 (in FIG. 7D, the seven connecting water passages 9a to 9g communicate with the water supplying pipe 20, and the connecting water passages 9i to 9o communicate with the water draining pipe 21, so that all of the cooling water flows through the annular water passage).

As is clear from the above description, in order to supply the cooling water to the annular water passage 8, there are effectively provided at least three connecting water passages 9.

With the above-described nozzle A, it is possible to achieve the cutting of a high quality when the nozzle A is used for the plasma cutting. In addition, the nozzle A can be applied to the plasma torch for use in fusing the workpiece or the plasma torch for welding.

1. A nozzle for a plasma torch, in which the nozzle is detachably attached to the plasma torch and has an injection port for injecting a plasma arc formed at the center thereof, the nozzle for a plasma torch comprising:
a water supplying pipe for cooling water;
a water draining pipe for the cooling water;
an annular water passage arranged around the injection port; and
a plurality of connecting water passages for independently connecting the water supplying pipe to the annular water passage and the water draining pipe to the annular water passage.

2. A nozzle for a plasma torch according to claim 1, wherein
the plurality of connecting water passages are arranged over the entire circumference of the nozzle, the water supplying pipe and the water draining pipe have enlarged ends, and the water supplying pipe and the water draining pipe are connected to the plurality of connecting water passages, respectively.

3. A nozzle for a plasma torch according to claim 2, wherein
the nozzle for a plasma torch has three or more connecting water passages arranged in such a manner as to divide the entire circumference of the nozzle at equal angles, at least one of the connecting water passages being connected to only either one of the water supplying pipe and the water draining pipe.

4. A nozzle for a plasma torch according to claim 1, wherein the connecting water passage and the annular water passage are formed at a joint surface between a first nozzle member and a second nozzle member in combination, which constitute the nozzle for a plasma torch.
